(19) United States
(12) Patent Application Publication
(10) Pub. No.: US 2003/0005105 A1
(43) Pub. Date: Jan. 2, 2003

(54) Method and apparatus for a common management software systems

(76) Inventor: Anne Robb, Casselberry, FL (US)

Correspondence Address: Siemens Corporation, Intellectual Property Department, 186 Wood Avenue South, Iselin, NJ, 08830, US

(21) Appl. No.: 10/159,204

(22) Filed: May 30, 2002

Related U.S. Application Data
(60) Provisional application No. 60/294,201, filed on May 30, 2001.

(51) Int. Cl. G06F 15/173

(52) U.S. Cl. 709/223

(57) ABSTRACT

An apparatus and method are provided that allows a telecommunications device, such as a switch, to be configured to support multiple communication protocols for the purpose of network management. The telecommunications device is provided with an interface that is adaptable to support a communications protocol selected by a requesting party. The telecommunications device is further provided with a management facility that is capable of handling multiple requests for management activities from multiple requesting parties. The interface translates each received request for management activities from each party into a format understandable by the management facility. In this manner, the telecommunications device avoids having to build or rebuild a party specific management facility for each party seeking to perform network management activities on the telecommunications device.

### RELATED APPLICATIONS

This application claims the benefit of priority under 35 U.S.C. 119(e) to copending U.S. Patent Provisional Applications, Serial No. 60/294,201 and filed on May 30, 2001, the contents of said application being incorporated by reference herein in its entirely.

This application is also related to the following U.S. patent applications: U.S. patent application Ser. No. ______ filed May 30, 2002 entitled AN INTEGRATED ACCESS PLATFORM; U.S. patent application Ser. No. ______ filed May 30, 2002 entitled METHOD FOR OPERATING AND APPARATUS FOR A BACK-PLANE SUPPORTING REDUNDANT CIRCUIT CARDS; U.S. patent application Ser. No. ______ filed May 30, 2002 entitled METHOD AND APPARATUS OF TESTING A POTS CIRCUIT AND DSL CIRCUIT THROUGH A SPLITTER; U.S. patent application Ser. No. ______ filed May 30, 2002 entitled METHOD AND APPARATUS FOR LOADING A MIRROR IMAGE SOFTWARE COPY ACROSS CIRCUIT CARDS; U.S. patent application Ser. No. ______ filed May 30, 2002 entitled METHOD AND APPARATUS FOR PROVIDING A COMMON TEXT MESSAGING SYSTEM WITHIN A SOFTWARE ARCHITECTURE; U.S. patent application Ser. No. ______ filed May 30, 2002 entitled METHOD AND APPARATUS FOR PROVIDING A STATE MACHINE OPERATING ON A REAL-TIME OPERATING SYSTEM; and U.S. patent application Ser. No. ______ filed May 30, 2002 entitled METHOD AND APPARATUS FOR ADMINISTERING MULTIPLE PROVISIONABLE OBJECTS, the contents of each of said applications being incorporated by reference herein in their entirely.

### TECHNICAL FIELD OF THE INVENTION

The present invention generally relates to a telecommunications device and, more particularly, to management of the telecommunications device.

### BACKGROUND OF THE INVENTION

Conventional telecommunications devices typically provide some mechanism for remotely accessing management functions for the device. A typical mechanism is a command line interface (CLI). The CLI is a user interface through which the user responds to a visual prompt from the telecommunication device by typing in a command on a specified line. The telecommunication device processes the command and returns a response to the user. At this point if the user has additional commands that the user wishes to process, the user enters the next command on the specified line in response to the visual prompt and continues in this manner until all commands or requests for management activities are entered.

The CLI user interface like other typical mechanisms for remotely accessing management functions for the device, such as simple network management protocol (SNMP) management station and agent, a mechanism that supports hypertext transfer protocol (HTTP) or other like mechanisms, require the device to provide dedicated processing operations for each mechanism the device supports. As such each mechanism is required to have a processing facility for processing the requests for management activities dedicated to each mechanism. These unique processing facilities are tailored to a user request syntax and cannot be shared amongst the various mechanisms. Accordingly, for each mechanism added to the device to support a user request syntax, a corresponding processing facility must be developed for each added mechanism. Consequently, the conventional mechanisms for remotely accessing management functions of telecommunications devices become burdensome to operate, configure, and maintain due to their overall complexity.

### SUMMARY OF THE INVENTION

The present invention addresses the above-described limitations of managing a telecommunications device. The present invention provides an approach to enable the telecommunications device to communicate with a variety of parties via a variety of protocols for the purposes of device management.

In one embodiment of the present invention, a telecommunications device has a management facility for managing the telecommunications device and an interface for receiving requests for performance of management activities. The management facility is responsive to the requests for performance of management activities from multiple requesters. The interface receives the requests for performance of the management activities from multiple requesters via multiple protocols and passes the requests to the management facility in a translated format that is understood by the management facility.

The interface is capable of receiving the requests for performance of management activities from the requesters via a network management protocol, such as the simple network management protocol (SNMP), or a web-connection via the hyper text transfer protocol (HTTP). The interface may be adapted to include a server for receiving and transmitting communications via HTTP with a requester. The interface may also include an SNMP agent for receiving and transmitting communications to an SNMP manager associated with a requester and a GR-303 stack for receiving and transmitting communications with a requester via the common management information protocol/common management information service element (CMIP/CMISE) suite of protocols.

The telecommunications device may be an integrated access platform for providing parties with access to a digital subscriber line (DSL) or to plain old telephone service (POTS) for both voice and data communications. The management facility is adaptable to transmit a response to a request for management activities in the file transfer protocol (FTP). In addition, the management facility is capable of performing multiple sessions with multiple requesters to perform multiple management activities in a substantially simultaneous manner. Moreover, the interface of the telecommunications device is extensible to add a translation facility that is capable of translating a request for management activities from a communications protocol to the format understandable to the management facility. Furthermore, the interface of the telecommunications device is flexible in that a translation facility of the interface is capable of being dropped for translating a request for management services to the format understandable to the management facility.

In accordance with another aspect of the present invention, a method is performed in a telecommunications device for communicating with one or more requesters to manage a portion of the telecommunications device. The telecommunications device receives multiple requests via multiple protocols from one or more requesters for managing a portion of the telecommunications device. The telecommunications device translates each request from one of the multiple protocols to another protocol understandable by a management facility of the telecommunications device. The request in the other protocol is passed to the management facility to manage a portion of the telecommunication device. In response, the management facility provides a response in the other protocol. The response in the other protocol is translated to the protocol used to communicate the request and returned via the original protocol to the requester. The telecommunications device is capable of receiving requests and transmitting responses via a variety of protocols.

In yet another aspect of the present invention, a device readable medium holding executable instructions for a telecommunications device associated with a network that allows the device to be managed by a number of requesters submitting a number of requests via a variety of protocols is provided. The device readable medium provides a management facility to manage the telecommunications device. The management facility is responsive to the multiple requests submitted by the multiple requesters.

The telecommunications device translates the multiple requests from the multiple protocols to a format suitable for the management facility to understand and transfers to the management facility the multiple requests in the format suitable for the management facility. The management facility processes the multiple requests in the format suitable for the management facility and generates a response to each of the multiple requests. The content of the response from the management facility is translated into one of the multiple protocols and is transmitted to the respective requester via the protocol suitable for the requester. In this manner multiple requesters communicating with the telecommunications device via multiple communication protocols can manage the device.

In a further aspect of the present invention, a method for managing operation of a telecommunications device that provides one or more connections to a telephone network is provided. The telecommunications device includes a management facility and is interfaced with multiple client devices. The telecommunications device receives multiple requests from the client devices for performing a management operation in the telecommunications device using the management facility. Each of the requests from the client devices is received via a variety of protocols. The telecommunications device translates each request from one of the multiple protocols to another protocol understandable by the management facility. The management facility is responsive to the request in the other protocol to support management of the telecommunications device by the multiple client devices.

The method allows the telecommunications device to unpack each request in the other protocol for the management facility to determine an action and a response for each of the multiple requests. Each response from the management facility is formatted in the other protocol, which is then translated to one of the multiple protocols and transmitted via one of the multiple protocols to the appropriate client device to support management of the telecommunications device by the client device.

### BRIEF DESCRIPTION OF THE DRAWINGS

An illustrative embodiment of the present invention will be described below relative to the following drawings, in which like reference characters refer to the same parts throughout the different views.

FIG. 1 illustrates a representation of the telecommunications device suitable for use in practicing the illustrative embodiment of the present invention.

FIG. 2 depicts a block diagram of the interface and the management facility of the telecommunications device suitable for practicing the illustrative embodiment of the present invention.

FIG. 3 is a flow diagram that depicts operation of the telecommunications device in an illustrative embodiment of the present invention.

FIG. 4 is a continuation of the flow diagram from FIG. 3.

FIG. 5 depicts various communication formats suitable for practicing an illustrative embodiment of the present invention.

FIG. 6 depicts a block diagram of the management facility suitable for use in practicing the illustrative embodiment of the present invention.

### DETAILED DESCRIPTION

The illustrative embodiment of the present invention provides a telecommunications device that communicates with a number of client devices via a variety of protocols for the purpose of managing the telecommunications device. In the illustrative embodiment, the telecommunications device is adapted to communicate with the multiple client devices via the multiple protocols without having a unique management facility built and dedicated for communications with each specific client device via a client selected protocol. The management facility of the telecommunications device through an interface portion of the telecommunications device is able process multiple requests for management activities from multiple clients without the need to build a custom or unique management facility for each client. As a result, the telecommunications device is able to translate a request received via a communication protocol to a request in a format understandable by a management facility of the telecommunications device to allow multiple requesters to perform management activities on the device via multiple protocols.

In the illustrative embodiment, the telecommunication device is attractive for use as an integrated access platform to provide multiple clients with voice and data connections to a network. The telecommunications device supports a client's legacy system for managing a telecommunications device and supports one or more alternate protocols available to the client for network management. Consequently, each client can move to an alternate system for managing the telecommunications device that communicates using a different protocol without having the operator of the telecommunications device build a unique management facility in a device to support the different protocol.

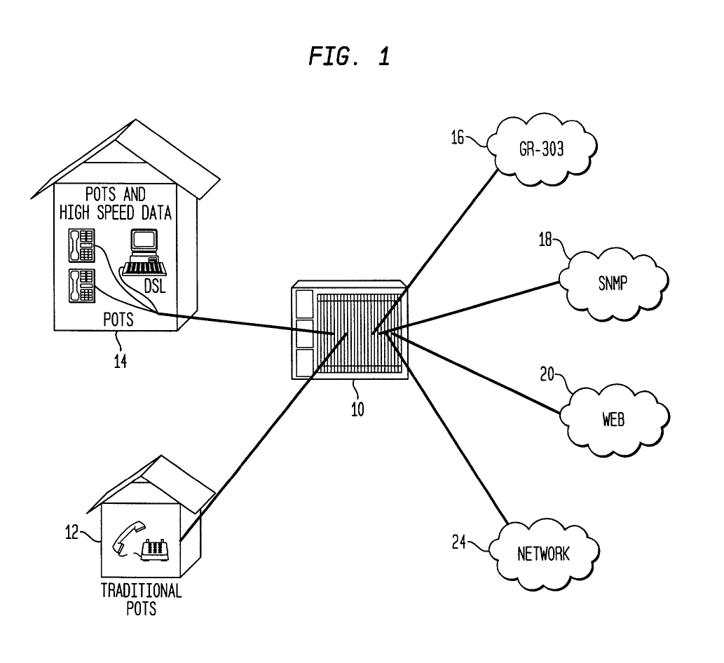

FIG. 1 illustrates an exemplary telecommunication device 10 in a network environment suitable for practicing the illustrative embodiment of the present invention. The exemplary telecommunication device 10 is capable of providing a first party 14 and a second party 12 with a connection to a network 24. For purposes of the discussion below, it is presumed that the exemplary telecommunication device 10 is considered an integrated access platform. Those skilled in the art will appreciate that the present invention may also be practiced with other types of telecommunication devices, including, but not limited to, routers, ATM switches, optical switches and the like. The exemplary telecommunication device 10 can provide multiple network connections of multiple types to a single party. For example, the exemplary telecommunication device 10 provides the first party 14 with a POTS connection and a DSL connection. In this manner, the exemplary telecommunication device 10 is capable of providing both voice and data communications to multiple parties.

Those skilled in the art will recognize that the first party 14 and the second party 12 are merely illustrative and that the exemplary telecommunication device 10 is capable of providing to one or more parties, over three hundred connections for POTS services and over four hundred connections for DSL services. Moreover, the exemplary telecommunication device 10 is capable of providing voice over DSL (VoDSL) and providing each party with access to a variety of network technologies, for example, asynchronous transfer mode (ATM), public switch telephone network (PSTN), frame relay, and internet protocol (IP).

The exemplary telecommunication device 10 is able to communicate with a variety of parties via a variety of protocols to allow each party to manage one of their connections to the network 24. The exemplary telecommunication device 10 is able to communicate with a party having a GR-303 interface 16, a party having a simple network management protocol (SNMP) interface 18, and a party having a web interface 20 without having to build a unique management facility for each interface to process requests for management activities in the exemplary telecommunication device 10. The exemplary telecommunication device 10 allows each party to select a preferred communication protocol for use in managing the exemplary telecommunication device 10. In this manner, a party can select a preferred protocol for use in communication with the exemplary telecommunication device 10 without having the operator of the exemplary telecommunication device 10 build a unique management facility to support management of the device by the party.

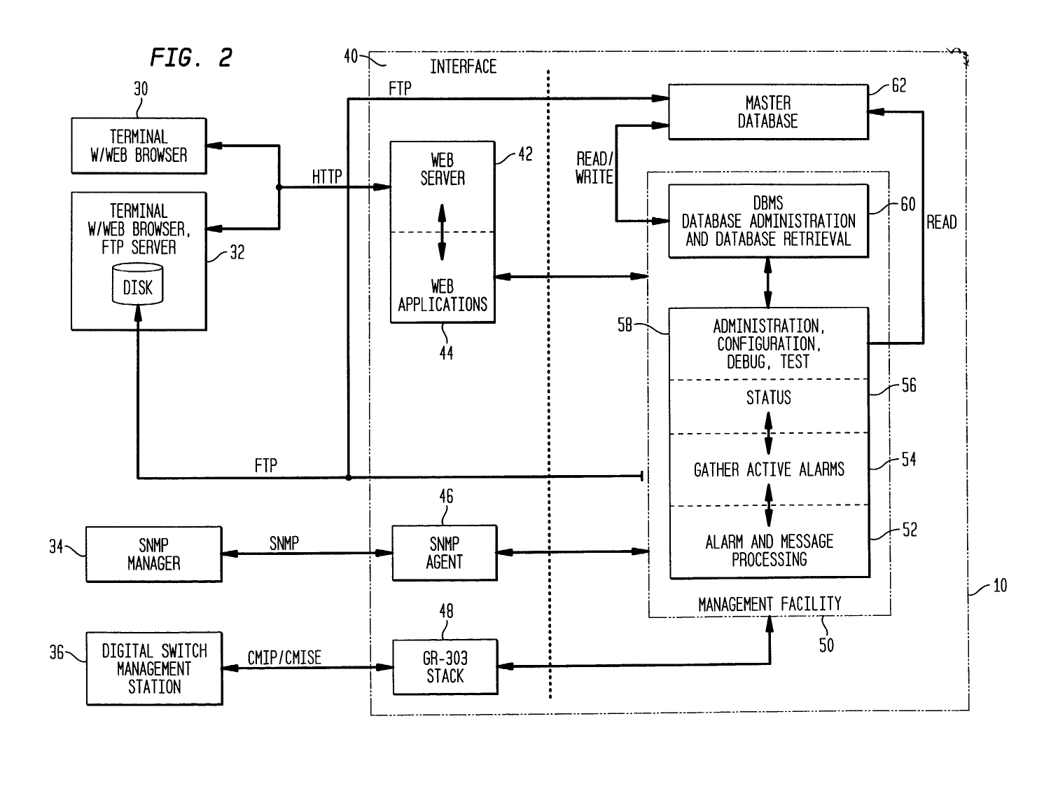

FIG. 2 illustrates the exemplary telecommunication device 10 in more detail. The exemplary telecommunication device 10 includes an interface 40 that communicates with a management facility 50. The interface 40 is responsible for communicating with the various party devices (i.e. a device associated with a party that is utilized by the party to communicate with the exemplary telecommunication device 10 for the purpose of network management) via a variety of protocols and for translating requests for management activities from each party into a format understandable by the management facility 50. The interface 40 is also responsible for translating a response from the management facility 50 from the format understandable by the management facility 50 to a format in which the corresponding request was received. In this manner, the interface 40 of the exemplary telecommunication device 10 can communicate with multiple party devices via multiple protocols without the need to have a unique interface for each party. Those skilled in the art will recognize that each party can communicate with the exemplary telecommunication device 10 via multiple protocols.

The interface 40 is able to communicate with a party device via a variety of protocols to receive requests for management activities and provide responses thereto. As such, the interface 40 can communicate with a party device having a web browser 30 or with a party device having a web browser and a file transfer protocol (FTP) server 32. The interface 40 is capable of communicating with an SNMP manager 34 associated with a party via the SNMP protocol and for communicating with a digital switch management station 36 associated with a party via the common management information protocol/common management information service element (CMIP/CMISE) suite of protocols.

The interface 40 utilizes a variety of interface components, both hardware and software components, to communicate with each party. Those skilled in the art will recognize that the interface 40 is adaptable to include all hardware components or all software components. The interface 40 includes a web server 42 to communicate with the party devices 30 and 32 via the hypertext transfer protocol (HTTP). The interface 40 is also capable of communicating data via FTP between a storage device associated with the party device 32 and a master database 62 or between a party device and the management facility 50. The interface 40 further includes a component adapted as an SNMP agent 46 to receive and transmit communications with the SNMP manager 34 via the SNMP suite of protocols. A GR-303 stack 48 is also included in the interface 40 for communicating with digital switch management station 36 via the CMIP/CMISE suite of protocols.

As such, the interface 40 of the exemplary telecommunication device 10 includes a number of interface components suitable for communicating with multiple party devices via a protocol selected by a user of the party device without having to build a unique interface for each party device. Moreover, the interface 40 is extensible and flexible. That is, the interface 40 is capable of adding or dropping an interface component as protocols are developed or become obsolete. As a consequence, an operator of the exemplary telecommunication device 10 is able to avoid the need to utilize valuable resources, such as manpower that were previously needed to build unique and customized interfaces for each new party, or each time a party wished to add or move to a different protocol for managing the exemplary telecommunication device 10.

The management facility 50 includes a database management system 60 for managing the master database 62. The management facility 50 further includes one or more processors for processing the requests for management activities. The requests for management activities relate to different tasks within the exemplary telecommunications device 10, for example, administrative tasks, configuration tasks, debug tasks and test tasks. To handle the various types of tasks, the management facility 50 includes a processor 56 for processing requests relating to a status task of the exemplary telecommunications device 10. A processor 54 is also included in the management facility 50 for gathering active alarms associated with the exemplary telecommunication device 10. A processor 52 of the management facility 50 is responsible for providing a response to requests that relate to alarm and message processing in the exemplary telecommunication device 10.

In operation, the interface 40 upon receipt of a request for management activities from one of the party devices translates the request into a format that is understandable by the management facility 50. To indicate the interface component that sent the request to the management facility 50, the communication that holds the request includes an interface identifier that identifies the sending interface component. The management facility 50 upon receipt of the request in the understandable format from the interface 40 forwards the request to a processor responsible for processing the type of task identified in the request.

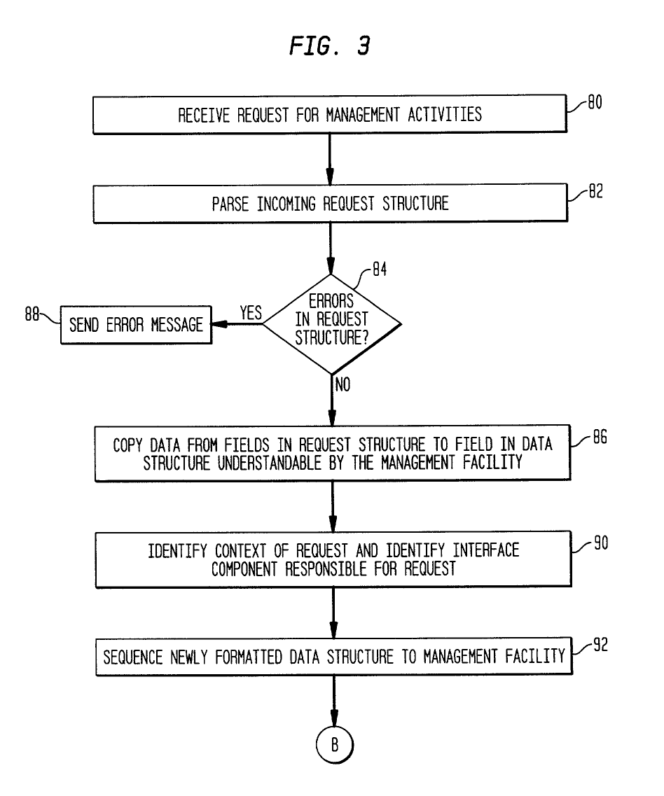

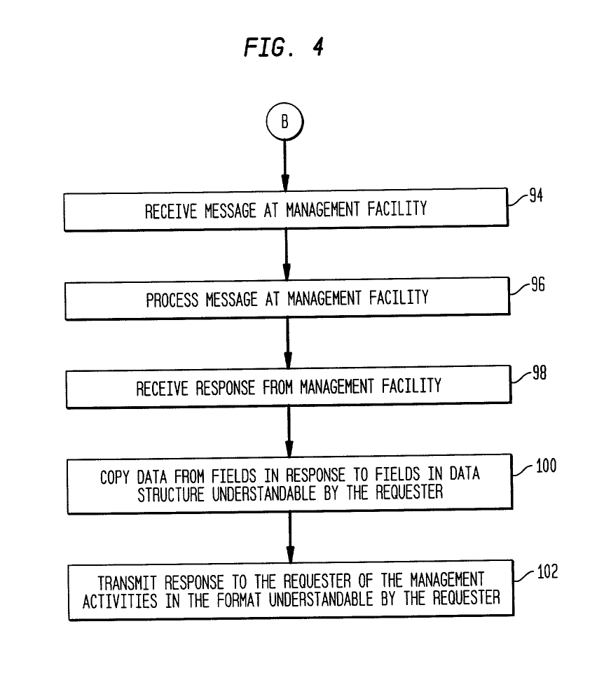

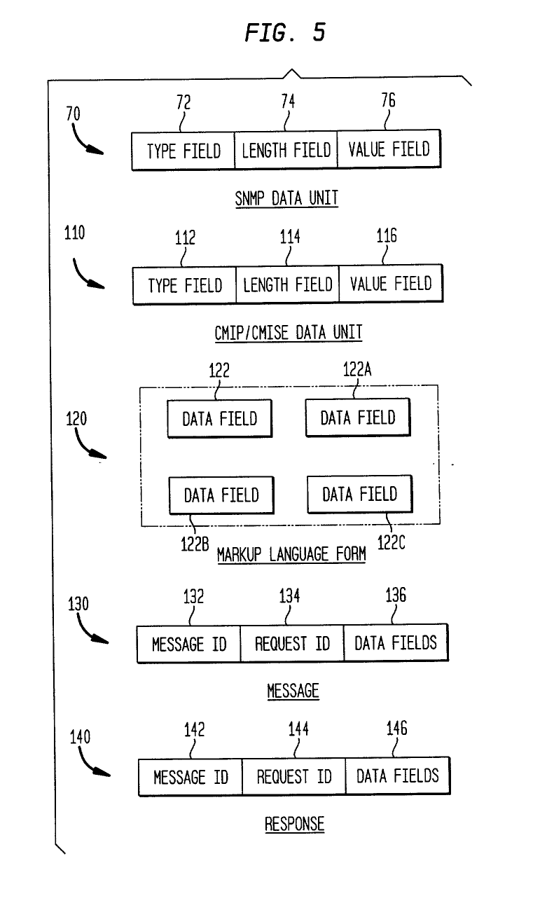

FIGS. 3 and 4 illustrate the steps taken by the interface 40 to translate a request into a format that is understandable by the management facility 50. FIG. 5 depicts various formats of the various communications the exemplary telecommunication device 10 utilizes and understands for the purpose of performing network management activities. FIG. 5 is discussed in conjunction with FIGS. 3 and 4 below.

When the interface 40 receives a request for management activities (Step 80 in FIG. 3), it parses the incoming request structure to identify fields or elements in the request for management services that pertain to requests for management activities (Step 82 in FIG. 3). A suitable data structure for sending a request for management activities can be a markup language data structure 120, a field in an SNMP datagram 70, or field in a CMIP/CMISE datagram 110. With regard to the markup language data structure 120, the parser is concerned with fields 122-122C. Fields 122-122C are identified with field names. The fields are named in a manner to identify session variables, selected elements and other like information. The parser verifies that all fields contain a value (Step 84 in FIG. 3). If no errors are present in the request for management activities, the value in each field 122-122C is copied to a corresponding field 136 in a data structure or message 130 understandable by the management facility 50 (Step 86 in FIG. 3). If there is an error present in the request for management activities, an error message is sent to party device that sent the request (Step 88 in FIG. 3).

The interface 40 continues to build the message by setting a value in a field of the message 130 named message ID, 132, and by setting a value in a field of the message named request ID 134 (Step 90 in FIG. 3). The message ID field 132 identifies what type of management activity is contained in the message, that is, the message ID identifies to the management facility 50 the type of task that the party is requesting. The value held in the request ID field 134 identifies the interface component that built the message. The value inserted in the message ID field 132 is determined from the context of the request submitted by party device. For example, if the party devices 30 and 32 submit a request for management activities via the web server 42, the web server 42 recognizes from the context of the requested content by the party devices 30 and 32 that the request pertains to a specific type of management activity or task. As such, if the user of the party device 30 and 32 selects content from the web server 42 that relates to administration tasks, the web server 42 upon receipt of the request for management services is able to identify that the request for management services relates to the downloaded administration content and sets the message ID field 132 to a value that indicates a request for administration tasks.

In similar fashion, the SNMP agent 46 and the GR-303 stack 48 are able to determine from a received request for management activity the type of activity or task requested and set the message ID field 132 in the message they build to a value that indicates the type of task requested. The SNMP agent 46 identifies from the request for management activities the type field 72 of SNMP datagram 70 along with assorted variable bindings, such as instance and object identifiers (OID's) also contained in the SNMP datagram 70 submitted by SNMP manager 34. The SNMP agent 46 uses the command type, the variable bindings and the OID to set the value of the message ID field 132 when building a message for the management facility 50. In addition, if the SNMP agent 46 recognizes that the appropriate command is set in the type field 72, the SNMP agent 46 copies the content of the value field 76 into the data field 136 of the message 130. The GR-303 stack 48, like the SNMP agent 46, identifies the CMIP/CMISE command in the type field 112 to set the value of the message ID field 132 when building a message for the management facility 50. In addition, if the GR-303 stack 48 recognizes that the appropriate command is set in the type field 112, the GR-303 stack 48 copies the content of the value field 116 into the data field 136 of the message 130.

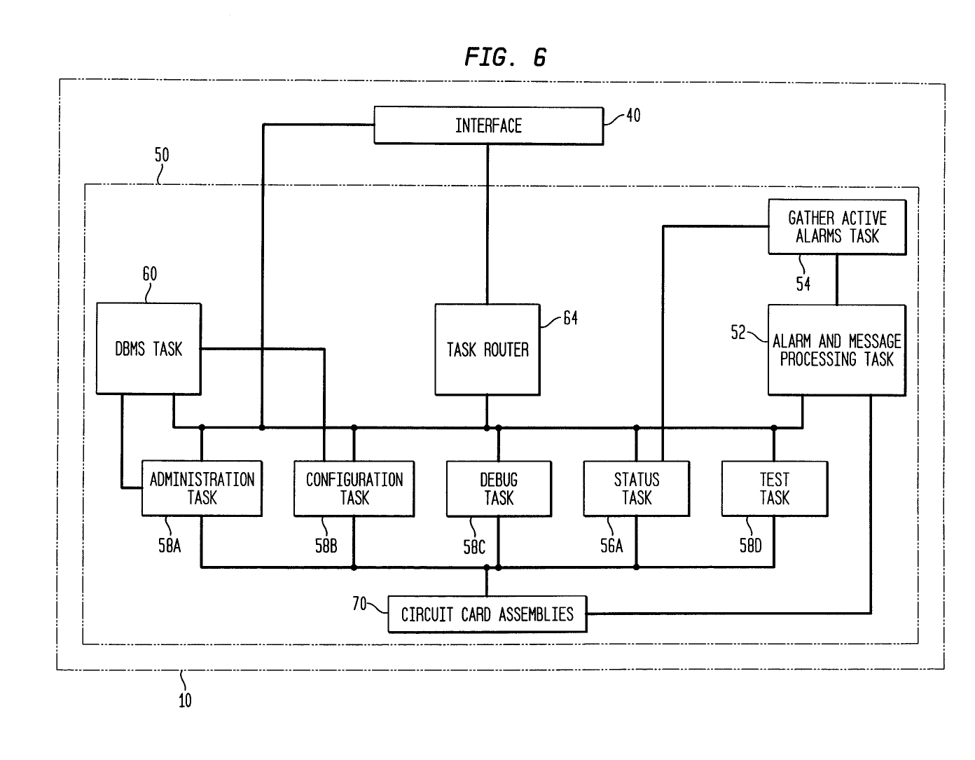

The interface 40 is responsible for sequencing the message 130 in a logical sequence to the management facility 50 for processing (Step 92 in FIG. 3). The message 130 from the web server 42, the SNMP agent 46 or the GR-303 stack 48, includes a value in the request ID field 134 in the message 130 for later use in determining which interface component is the originator of the message 130. The management facility 50, upon receipt of a message 130 from the web server 42, the SNMP agent 46 or the GR-303 stack 48, also examines the message ID field 132 to route the message to an appropriate one of the processors in the management facility 50, 58A, 58B, 58C, 58D, and 56A for processing (Step 94 in FIG. 4). The various processors available in the management facility 50 for processing of the message is discussed below in more detail with reference to FIG. 6.

The appropriate processor within the management facility 50 processes the requested management activity and returns a response 140 in the format understandable by the management facility 50 (Step 96 in FIG. 4). The management facility 50 reads the request ID field 144 in the response 140 to identify which component of the interface 40 should receive the response 140 and forwards the response 140 thereto for translation into a format understandable by the party device requesting the management activity (Step 98 in FIG. 4). The responsible interface component then copies a value from each of the data fields 146 from the response 140 to a corresponding field in a response data structure suitable for sending to a requester (Step 100 in FIG. 4). Upon translating the response 140 to a format understandable by the requester the interface 40 transmits the response to the party device via the appropriate protocol (Step 102 in FIG. 4).

FIG. 6 illustrates the management facility 50 in more detail. A task router 64 is in communication with the interface 40 and is responsible for routing the requests for management activities from each of the parties to the appropriate processor for processing based on the message ID in the message. The task router 64 routes the message from the interface 40 to either the administration task processor 58A, the configuration task processor 58B, the debug task processor 58C, the test task processor 58D, and the status task processor 56A to process the request for management activity from the party device. If necessary to process the request of management activity, each of the processors 58A, 58B, 58C, 58D, and 56A can communicate with an alarm and message task processor 52 to process an alarm and message related task. In addition, the status task processor 56A and the alarm and message task processor 52 are able to interface with the gather active alarm task processor 54 for gathering active alarms in the exemplary telecommunications device 10.

The management facility 50 is able to process multiple requests from multiple parties in parallel. That is, the management facility 50 is able to perform multiple sessions using processors 58A, 58B, 58C, 58D and 56A. Processors 58A, 58B, 58C, 58D and 56A are able to process up to five requests at a time.

Each processor within the management facility 50 also communicates, directly or indirectly, with a variety of circuit card assemblies 70 that are housed within the exemplary telecommunication device 10. The circuit card assemblies 70 are capable of providing the physical connections for each party to the network 24 or capable of providing other processing capability for the exemplary telecommunications device 10. Each of the processors in the management facility 50 is able to communicate, either directly or indirectly, with a selected one of the circuit card assemblies 70 to request information regarding a status, a configuration or the like, or to instruct a selected one of the circuit card assemblies 70 to perform a requested task, such as the performance of a self test. Each of the processors 58A, 58B, 58C, 58D and 56A return a response directly to the interface 40 based on a request ID of the message sent by the interface 40. Optionally, each of the processors 58A, 58B, 58C, 58D and 56A return a response to the router task 64 for routing the response to the appropriate component of the interface 40 based on the request ID for the message sent by the interface 40.

While the present invention has been described with reference to a preferred embodiment thereof, one skilled in the art will appreciate that various changes in form detail may be made without departing from the intended scope of the present invention as defined in the pending claims. For example, additional interface components can be added to the interface 40 as protocols are modified or newer protocols are established. In a similar fashion, an interface component of the interface 40 can be dropped should a protocol or a version of a protocol become obsolete or if a telecommunications provider decides to stop supporting a selected protocol.

What is claimed is:

1. A telecommunications device for use in a network, said device comprising:
a management facility for managing said device, said management facility being responsive to requests for performance of management activities from requesters;
an interface for receiving said requests for performance of said management activities from multiple ones of said requesters via multiple protocols and for passing said requests to the management facility in a translated format that is understood by said management facility.

2. The telecommunications device of claim 1, wherein the interface includes a component for receiving said requests for performance of said management activities from said requesters via a network management protocol.

3. The telecommunications device of claim 2, wherein the network management protocol is the Simple Network Management Protocol (SNMP).

4. The telecommunications device of claim 1, wherein said interface includes a component for receiving said requests for performance of said management activities via a dial up connection.

5. The telecommunications device of claim 4, wherein said interface includes a component for receiving said requests for performance of said management activities over a web connection.

6. The telecommunications device of claim 1, wherein the device is an integrated access platform.

7. The telecommunications device of claim 1, wherein said interface further comprises,
a hypertext transfer protocol (HTTP) agent to receive communications from, and for transmitting responses to at least one of said requesters;
a simple network management protocol (SNMP) agent for receiving communications from, and for transmitting responses to an SNMP manager associated with at least one of said requesters in a SNMP protocol; and
a GR-303 stack for receiving communications from and for transmitting responses to at least one requester having a management station communicating in a protocol selected from the common management information protocol/common management information service element (CMIP/CMISE) suite of protocols.

8. The telecommunications device of claim 1, wherein the management facility has a module for transmitting a response to one of said requests from one of said requesters in the File Transfer Protocol (FTP).

9. The telecommunications device of claim 1, wherein said device comprises a switch connecting a party to a telephone network.

10. The telecommunications device of claim 1, wherein said device comprises a switch capable of providing a party access to a digital subscriber line (DSL).

11. The telecommunications device of claim 1, wherein said management facility is capable of performing multiple sessions with multiple requesters to perform said management activities.

12. The telecommunications device of claim 1, wherein said interface provides an extensible translation facility for translating said requests in said multiple protocols to said translated format, said extensible translation facility being capable of adding an agent for translating said requests in said multiple protocols.

13. The telecommunications device of claim 1, wherein said interface provides a flexible translation facility for translating said requests in said multiple protocols to said translated format, said flexible translation facility being capable of dropping an agent for translating said requests in said multiple protocols.

14. In a telecommunications device, a method for communicating with one or more requesters to manage said telecommunications device, said method comprising the steps of:
receiving multiple requests via a plurality of protocols from said one or more requesters for managing said telecommunications device;
translating each request of said multiple requests from one of said plurality of protocols to another protocol understandable by a management facility of said telecommunications device; and
passing each of said multiple requests in said other protocol to said management facility for managing said telecommunications device from said requester.

15. The method of claim 14, further comprising the steps of,
receiving a response to said request from said management facility, said response received in said other protocol;
translating said response from said other protocol to said protocol used to transmit said request from said one of said multiple requesters; and
returning said response via said protocol used to transmit said request to said requester.

16. The method of claim 14, wherein said telecommunications device receives said requests for managing a portion of said telecommunications device via a Simple Network Management Protocol (SNMP).

17. The method of claim 14, wherein said telecommunications device receives said requests for managing a portion of said telecommunications device over a web connection.

18. The method of claim 14, wherein said telecommunications device provides an integrated access platform for voice and data communications.

19. The method of claim 14, wherein said telecommunications device receives said requests for managing a portion of said telecommunications device via a Common Management Information Protocol/Common Management Information Service Element (CMIP/CMISE).

20. The method of claim 15, further comprising the step of returning said response via a protocol selected from a File Transfer Protocol (FTP) suite of protocols.

21. A device readable medium holding executable instructions for a telecommunications device associated with a network, said device readable medium allowing said device to be managed by a plurality of requesters submitting a plurality of requests via a plurality of protocols by performing the steps of:
providing a management facility to manage the telecommunications device, the management facility being responsive to said plurality of requests submitted by said plurality of requesters;
translating said plurality of requests from said plurality of protocols to a format suitable for said management facility to understand; and
transferring to said management facility said plurality of requests in said format suitable for said management facility to understand for allowing said telecommunications device to be managed by said plurality of requesters.

22. The device readable medium of claim 21, further performing the steps of:
processing said plurality of requests in said format suitable for said management facility in said management facility using multiple sessions;
generating a response to each of said plurality of requests, said response resulting from said processing; and
translating said response into one of said plurality of protocols for transmission to a selected one of said plurality of requesters.

23. The device readable medium of claim 21, wherein said device comprises a switch for connecting each of said plurality of requesters to a telephone network.

25. A method for managing operation of a telecommunications device having a management facility, said telecommunications device providing one or more connections to a telephone network, the method comprising the steps of:
interfacing said telecommunications device with multiple client devices to provide said multiple client devices with multiple connections to said telephone network;
receiving multiple requests from said multiple client devices for performing at least one management operation in said telecommunications device using said management facility, each of said multiple requests being received via a plurality of protocols; and
translating each of said multiple requests from said plurality of protocols to an other protocol understandable by said management facility, said management facility being responsive to said request in said other protocol to support management of said telecommunications device by said multiple client devices.

26. The method of claim 25, further comprising the steps of,
unpacking each of said multiple requests in said other protocol to determine an action and a response for said management facility for each of said multiple requests;
formatting each said response to each of said multiple requests in said other protocol;
translating each said response to each of said multiple requests from said other protocol to one of said plurality of protocols; and
transmitting multiple responses via said plurality of protocols to said multiple client devices to support management of said telecommunications device by said multiple client devices.

27. The method of claim 25, wherein said device comprises a switch providing an integrated access platform for both voice and data transmissions on said telephone network.
